(19) United States
(12) Patent Application Publication
(10) Pub. No.: US 2017/0347430 A1
(43) Pub. Date: Nov. 30, 2017

(54) LIGHTING CONTROL DEVICE AND LIGHTING SYSTEM

(71) Applicant: Panasonic Intellectual Property Management Co., Ltd., Osaka (JP)

(72) Inventors: Yoshinobu MURAKAMI, Osaka (JP); Atsuo NANAHARA, Kyoto (JP)

(21) Appl. No.: 15/606,435

(22) Filed: May 26, 2017

(30) Foreign Application Priority Data
May 30, 2016 (JP) 2016-107604

(51) Int. Cl. H05B 37/02

(52) U.S. Cl. CPC H05B 37/0218; H05B 37/0272; H05B 37/0281

(57) ABSTRACT

A lighting control device that controls a lighting device includes: a brightness sensor that obtains brightness information indicating the current brightness of an illuminated surface illuminated by the lighting device; a controller that obtains the brightness information from the brightness sensor; and a transmitter that wirelessly transmits, to the lighting device, a control signal generated by the controller for controlling the lighting device. The controller determines a waiting time based on the brightness information and transmits the control signal to the lighting device via the transmitter after elapse of the waiting time from a predetermined time.

### CROSS REFERENCE TO RELATED APPLICATION

This application claims the benefit of priority of Japanese Patent Application Number 2016-107604 filed on May 30, 2016, the entire content of which is hereby incorporated by reference.

### BACKGROUND

### 1. Technical Field

The present disclosure relates to a lighting control device that executes feedback control on an output of a lighting device based on the measured brightness of an illuminated surface.

### 2. Description of the Related Art

A lighting apparatus configured to execute feedback control on an output (dimming rate) of a lighting device based on the measured brightness of an illuminated surface has been proposed (for example, see Japanese Unexamined Patent Application Publication No. H10-302968). Such a lighting apparatus inhibits the output of the lighting device to conserve energy by maintaining the brightness of the area to be illuminated to within a certain range while making use of the brightness provided by daylight entering the room from, for example, a window.

Moreover, a lighting control device that executes such control over a plurality of candidate lighting devices via wireless communication has been proposed (for example, see Japanese Unexamined Patent Application Publication No. 2014-107230).

### SUMMARY

A lighting control device that communicates with a plurality of lighting devices via wireless communication, such as the device described above, avoids communication congestion and cross talk by pausing transmission after performing carrier sense and then resuming transmission.

A plurality of such lighting control devices are installed in large rooms in which many lighting devices are installed, such as a room found in a place of business. In this case, communication congestion may occur as a result of these lighting control devices transmitting at the same time. The pausing and resuming of transmission as described above provides an advantageous effect to a certain degree with regard to avoiding congestion, but there is a problem that the pausing and resuming may occur frequently.

The present disclosure is conceived in view of the above problem, and has an object to provide a lighting control device that inhibits communication congestion even when a plurality of the lighting control devices are installed in the same room and used at the same time.

In order to overcome the above problem, a lighting control device according to one aspect of the present invention controls a lighting device and includes: a brightness sensor that obtains brightness information indicating the current brightness of an illuminated surface illuminated by the lighting device; a controller that obtains the brightness information from the brightness sensor; and a transmitter that wirelessly transmits, to the lighting device, a control signal generated by the controller for controlling the lighting device. The controller determines a waiting time based on the brightness information and transmits the control signal to the lighting device via the transmitter after elapse of the waiting time from a predetermined time.

With the lighting control device according to one aspect of the present invention, communication congestion is inhibited even when a plurality of the lighting control devices are installed in the same room and used at the same time.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram illustrating an example of a configuration of a lighting system including a plurality of lighting control devices according to an embodiment;

FIG. 2 is a block diagram illustrating an example of a functional configuration of the lighting control device according to the embodiment;

FIG. 3 is a block diagram illustrating an outline of operations relating to a feedback control system in the lighting system;

FIG. 4 is a flowchart illustrating the feedback control steps performed in lighting control devices according to the embodiment;

FIG. 5 is a sequence chart for illustrating the cycle of steps for determining the waiting time based on a plurality of brightness information values, performed in the lighting control devices according to the embodiment; and

FIG. 6 is a flowchart illustrating the steps for control of the lighting devices based on the external instruction signal, performed in the lighting control devices according to the embodiment.

### DETAILED DESCRIPTION OF THE EMBODIMENT

The following describes an embodiment of the present disclosure with reference to the drawings. Note that the embodiment described below shows a specific example of the present disclosure. The numerical values, shapes, materials, elements, the arrangement and connection of the elements, steps, the order of the steps, etc., indicated in the following embodiment are mere examples, and therefore do not intend to limit the inventive concept. Therefore, among elements in the following embodiment, those not recited in any of the independent claims defining the most generic part of the inventive concept are described as optional elements

Note that the drawings are represented schematically and are not necessarily precise illustrations. Further, like reference signs in the drawings indicate like elements. As such, overlapping explanations of like elements are omitted or simplified.

### Embodiment

Hereinafter, a lighting control device according to this embodiment will be described.

### (1. Configuration)

### (1-1. Lighting System Configuration)

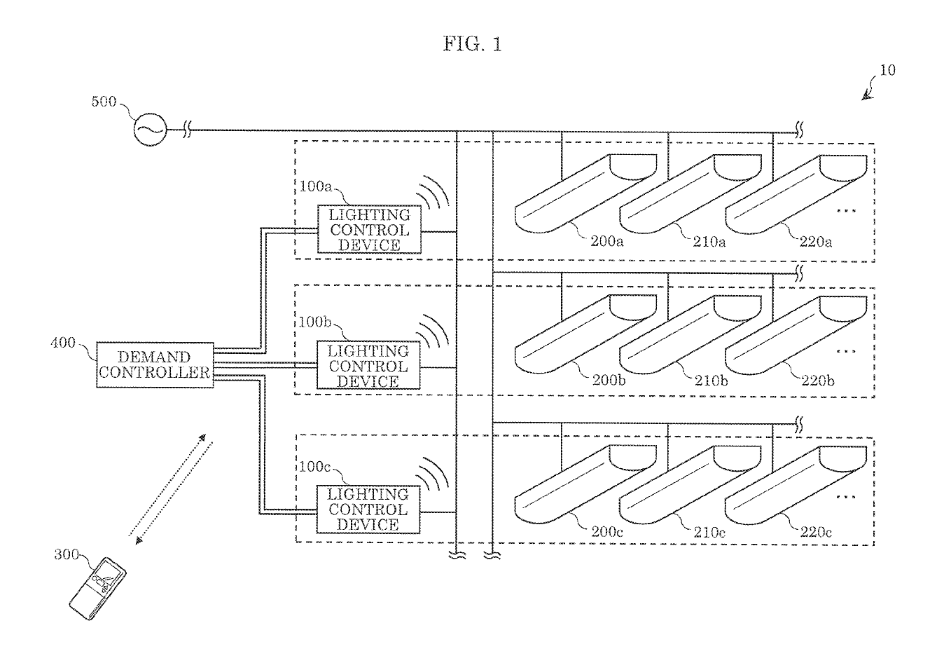

First, in order to describe the role of the lighting control device according to this embodiment in the consumer location, the configuration of the lighting system including the lighting control device will be described. FIG. 1 illustrates an example of a configuration of lighting system 10 including lighting control devices 100a through 100c according to the embodiment.

Lighting system 10 is installed in an energy consumer location, such as a place of business, and includes, in addition to lighting control devices 100a through 100c, lighting devices 200a through 200c, 210a through 210c, and 220a through 220c, remote control 300, demand controller 400, and power supply 500. For example, lighting control devices 100a through 100c can be installed in different rooms or different buildings at a consumer location, but in the example to be given hereinafter, lighting control devices 100a through 100c are installed in the same room, as such a setup would easily congest communication in the case of conventional lighting control devices.

Power supply 500 is an AC utility power supply. Lighting control devices 100a through 100c, lighting devices 200a through 200c, 210a through 210c, and 220a through 220c, and demand controller 400 receive power necessary for each to operate from power supply 500.

Lighting control devices 100a through 100c control the turning on and off of the lighting devices, as well as the output (dimming rate: 100% indicating maximum output and 0% indicating zero output) of lighting devices 200 when lighting devices are on, in accordance with instructions from remote control 300 and demand controller 400. Note that each of lighting control devices 100a through 100c has the same configuration, but differ in regard to which lighting devices they control. In FIG. 1, each combination of a lighting device and the lighting control devices that the lighting device controls is surrounded by a dashed line. In other words, the lighting devices that lighting control device 100a controls are lighting device 200a, 210a, and 220a. The lighting devices that lighting control device 100b controls are lighting device 200b, 210b, and 220b. The lighting devices that lighting control device 100c controls are lighting device 200c, 210c, and 220c. Lighting control devices 100a through 100c wirelessly transmit control signals to the lighting devices that they control. For example, the installer uses remote control 300 to pair each lighting control device with the lighting devices they are to control upon installing lighting system 10 to set up such wireless communication.

Note that hereinafter, the recitation of “lighting control devices 100” and “lighting control device 100” will be used when it is not necessary to differentiate between lighting control devices 100a through 100c. In the example illustrated in FIG. 1, lighting system 10 includes three lighting control devices 100. However, this example does not limit the number of lighting control devices 100 that lighting system 10 is capable of including. Moreover, the recitation of “lighting devices 200” and “lighting device 200” will be used when it is not necessary to differentiate between lighting devices 200a through 200c, 210a through 210c, and 220a through 220c. In the example illustrated in FIG. 1, each lighting control device 100 controls three lighting devices 200, but this example does not limit the number of lighting devices 200 that each lighting control device 100 is capable of controlling. Moreover, the number of lighting devices 200 controlled by each lighting control device 100 need not be the same.

Lighting devices 200 are installed in, for example, the ceiling of a building, such as a place of business, in the consumer location. Note that each lighting device 200 has the same configuration. Each lighting device 200 includes a light source (not illustrated in the drawings) and a transmitter (not illustrated in the drawings) for wirelessly communicating with its parent lighting control device 100.

The light source in each lighting device 200 is, for example, a light-emitting diode (LED) light source. The output of the light source is variable via pulse width modification (i.e., the light source is dimmable). In this case, output control performed by lighting control devices 100a through 100c is pulse width modification control.

Remote control 300 is a device operated by a user to switch lighting devices 200 on or off and adjust the brightness of lighting devices 200. When the user operates remote control 300, a signal based on this operation (hereinafter also referred to as an operation signal) is transmitted from remote control 300 to lighting control devices 100. Like with the pairing described above, remote control 300 may also be used for setting various parameters in lighting system 10 by, for example, a user or the installer. This sort of remote control 300 can be realized as, for example, an infrared remote control that communicates with each lighting control device 100 using infrared light as a medium.

Note that a plurality of remote controls 300 may be provided, one dedicated to each lighting control device 100, and, alternatively, a single remote control 300 may be used for all lighting control devices 100. When a single remote control 300 is used, the single remote control 300 may be capable of transmitting operation signals instructing the same operation (for example, turning all lighting devices 200 on or off) for all lighting devices 200 to all lighting control devices 100 simultaneously.

Demand controller 400 is a device installed in, for example, a power receiving facility in the consumer location, and is for monitoring power usage in the consumer location in real-time. When power usage is estimated to exceed a predetermined value, demand controller 400 inputs, into, for example, each lighting control device 100, a signal instructing execution of energy-saving light emission by lighting devices 200 (hereinafter, this signal is also referred to as an energy-saving signal). Demand controller 400 may receive a signal demanding conservation of power via a communication network from outside lighting system 10, e.g., from the power company, and may input the energy-saving signal into each lighting control device 100 in accordance with this demand.

The configuration of lighting system 10 set forth above is merely one example; possible configurations for the lighting system that can include lighting control device 100 according to this embodiment are not limited to this example.

For example, remote control 300 may communicate with lighting control device 100 via a wireless system that uses a communication medium other than infrared light. For example, a communication system conforming to some standard, such as Bluetooth (registered trademark) or ZigBee (registered trademark), may be used. Moreover, remote control 300 need not be a portable device as illustrated in FIG. 1; remote control 300 may be fixed to a wall and may communicate with lighting control device 100 over a wired connection. Moreover, both wired and wireless communication may be performed in lighting system 10. Remote controller 300 may be a part of lighting control device 100.

Moreover, remote control 300 does not directly communicate with each lighting control device 100, but rather is configured so as to be able to perform communication, such as the communication described above, via a relay (not illustrated in the drawings). In this case, for example, regarding simultaneous transmission of the operation signal to each lighting control device 100 from remote control 300, a signal may be transmitted from remote control 300 to the relay in one-to-one correspondence, and the signals may be transmitted from the relay to lighting control devices 100 at the same time via, for example, multicast. Moreover, a relay (not illustrated in the drawings) may be provided between each lighting control device 100 and the lighting devices that the lighting control device 100 controls.

Moreover, the light source included in each lighting device 200 is not limited to an LED light source. For example, the light source may be some other type of light source that is dimmable, such as an organic electroluminescent (EL) light source. Moreover, the method of controlling the output of the light source is not limited to the example of pulse width modification given above; methods suitable for various light sources may be used.

### (1-2. Lighting Control Device Configuration)

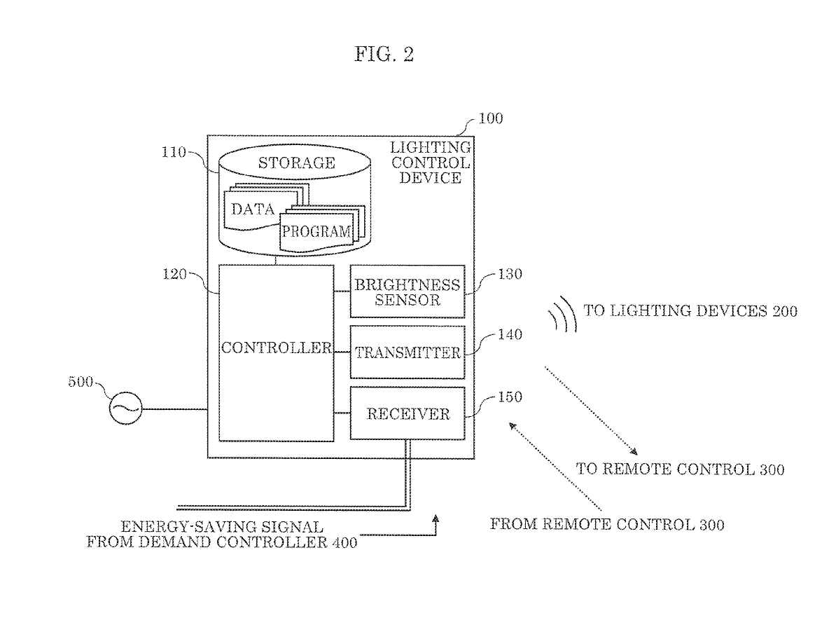

Next, the configuration of lighting control device 100 according to this embodiment will be described. FIG. 2 is a block diagram illustrating an example of the functional configuration of lighting control device 100 according to this embodiment.

Each lighting control device 100 includes storage 110, controller 120, brightness sensor 130, transmitter 140, and receiver 150.

Storage 110 stores a program to be executed by controller 120, which is to be described later, and data obtained and referenced for predetermined processing performed by controller 120 executing the program. An example of such data is data indicating the settings set in lighting system 10. Moreover, the brightness target value, which is used in the feedback control for lighting device 200 performed in lighting system 10, is also stored in storage 110 and is also data obtained and referenced by controller 120. Moreover, data generated during or as a result of processes performed by controller 120 is stored in storage 110 as necessary. Storage 110 is realized as, for example, read-only memory (ROM) and random access memory (RAM) in a microcontroller included in lighting control device 100.

Controller 120 reads the above program from storage 110 and executes the program to generate a signal for controlling lighting devices 200 (hereinafter also referred to as a control signal). For example, controller 120 generates the control signal by outputting a signal indicating the results of calculations made by running the above program. Alternatively, the control signal may be generated by outputting a signal indicating a command selected from data stored in storage 110 in accordance with the program. The generated control signal is wirelessly transmitted via transmitter 140 (to be described later) to each lighting device 200 controlled by lighting control device 100. An example of such control includes feedback control for lighting devices 200 executed based on the above-described data stored in storage 110 or the information or signal obtained from brightness sensor 130 or receiver 150 (to be described later). Feedback control will be described later in conjunction with the description of operations performed by lighting control device 100. Controller 120 is realized as, for example, a processor of a microcontroller included in lighting control device 100. Moreover, this microcontroller includes a timer, and cyclic operations (to be described later) performed by controller 120 are executed based on time measured by this timer.

Brightness sensor 130 obtains the current brightness of the surface of an object (illuminated surface), such as the floor or furniture, in an area illuminated by light from the controlled lighting devices 200, and successively transmits the obtained brightness to controller 120. More specifically, brightness sensor 130 is realized using a sensor, such as, a light sensor that converts light into electricity, and senses light reflected from, for example, the floor or the top of a desk in the area illuminated by the controlled lighting devices 200 and converts the light into voltage in accordance with the intensity of the light. A signal based on the value of this voltage is input into controller 120. A signal based on a voltage value is, for example, a signal that has been processed as necessary. Examples of such processing include amplification, noise removal, and A/D conversion. Note that in order to perform such processing, brightness sensor 130 may include, for example, an amplifier circuit, a filter circuit, and/or an A/D converter circuit. In this way, brightness sensor 130 obtains and outputs brightness information indicating the current brightness of an illuminated surface, and controller 120 obtains this brightness information. How the brightness information is used by controller 120 will be described later in conjunction with the description of operations performed by lighting control device 100. Brightness sensor 130 may be remotely arranged from lighting control device 100 and communicate with lighting control device 100 with a wired or a wireless communication.

Transmitter 140 is realized as, for example, an output port and wireless module of a microcontroller included in lighting control device 100, and wirelessly transmits a control signal generated by controller 120 to lighting devices 200 controlled by the lighting control device 100. Moreover, when remote control 300 is an infrared remote control as is the case in the above example, transmitter 140 may be realized using an infrared communication module. The current settings are transmitted from transmitter 140 to remote control 300 when, for example, lighting system 10 which uses remote control 300 is being set up.

Receiver 150 is, for example, an input port of a microcontroller included in lighting control device 100, and controller 120 receives, from an external device external to lighting control device 100 via receiver 150, a signal indicating a predetermined operation for the controlled lighting devices 200. As a more specific example, an energy-saving signal relating to execution of demand control—that is to say, energy-saving light emission by lighting devices 200—is received from demand controller 400, which is an external device.

In lighting control device 100, whether to execute energy-saving light emission by lighting devices 200 is determined based on whether or not controller 120 is currently receiving the energy-saving signal. The energy-saving signal is input into lighting control device 100 by dry contact input, for example. In this case, for example, controller 120 detects the state of the contact input in a regular cycle via the input port, and when controller 120 detects an OFF state a predetermined number of consecutive times, controller 120 receives the energy-saving signal by determining that the energy-saving signal has been input. While detection of the OFF state continues, controller 120 continuously receives the energy-saving signal. Then, when the ON state is detected a predetermined number of consecutive times, controller 120 determines that there is no input of the energy-saving signal, whereby controller 120 enters a state in which it is not receiving the energy-saving signal.

Moreover, in the case of this example, the dimming rate used when controller 120 is receiving the energy-saving signal is not indicated by the energy-saving signal, but is stored in advance in storage 110 as a set value. This dimming rate may be set by, for example, the installer upon installing lighting system 10. Controller 120 obtains this dimming rate from storage 110, and executes control for energy-saving light emission by the controlled lighting devices 200 using the obtained dimming rate.

Moreover, remote control 300 is also an external device external to lighting control device 100. Moreover, a signal in accordance with an operation made on remote control 300 by the user or the installer is input from remote control 300 into controller 120 via receiver 150. The signal transmitted from remote control 300 indicates, for example, an operation, such as an instruction for switching on or off lighting devices 200 or adjusting the brightness of lighting devices 200, or indicates the content of the settings or an instruction related to the settings. Note that when remote control 300 is an infrared remote control as is the case in the above example, receiver 150 may be realized using an infrared communication module.

### (2. Operations)

Next, operations performed by each lighting control device 100 will be described.

### (2-1. Routine Operations)

First, the feedback control, which is an example of operations routinely performed by each lighting control device 100 in lighting system 10, will be described. Operations relating to the feedback control system are performed by each above-described element in lighting control device 100 working in cooperation.

### (2-1-1. Feedback Control Outline)

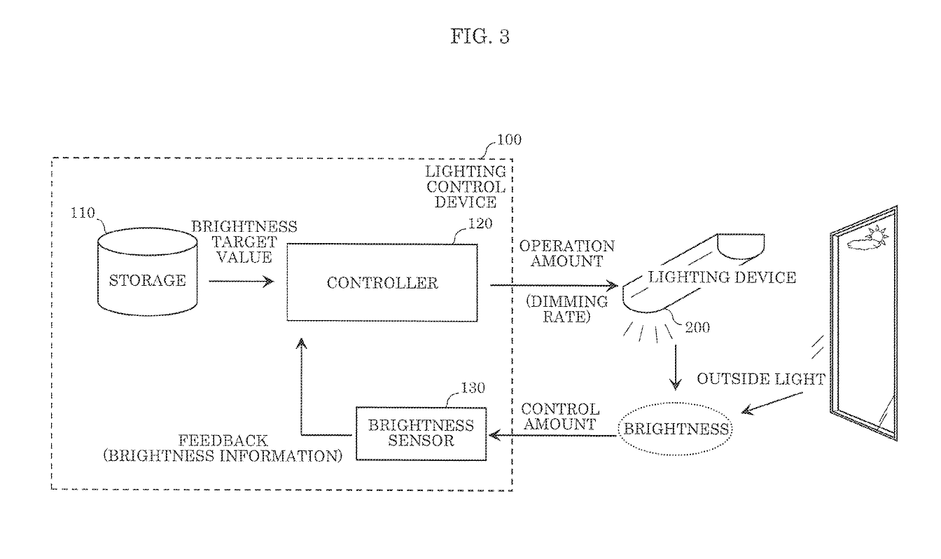

FIG. 3 is a block diagram illustrating an outline of operations relating to the feedback control system in lighting system 10.

In this feedback control, the dimming rate of lighting devices 200 is controlled so as to maintain the brightness of the illuminated surface illuminated by lighting devices 200 at a brightness target value that is set in advance. For example, when light originating from outside the system is incident on the illuminated surface, the dimming rate for lighting devices 200 is reduced (i.e., the light intensity is reduced) to a value less than when no such outside light is incident. Moreover, the dimming rate for lighting devices 200 is increased (i.e., the light intensity is increased) when, for example, it is cloudy and the intensity of outside light that reaches the illuminated surface is weak.

The setting of the brightness target value used in the feedback control is done using, for example, brightness sensor 130. More specifically, first, lighting devices 200 are turned on when there is no influence from outside light (e.g., during nighttime). Next, the installer or user adjusts the dimming rate for lighting devices 200 using remote control 300, then sets the brightness target value when a desired brightness is achieved. At this time, the value indicating the brightness of the illuminated surface illuminated by lighting devices 200, which is measured and obtained by brightness sensor 130, is stored in storage 110 as the brightness target value.

First, in the feedback control, controller 120 obtains the brightness target value from storage 110, and obtains brightness information indicating the current measured brightness of the illuminated surface from brightness sensor 130. The brightness of the illuminated surface is the control amount used in the feedback control system. Moreover, this feedback control system is disturbed by, for example, outside light.

Next, controller 120 compares and calculates the difference between the brightness target value and the brightness indicated by the brightness information. When there is a difference, controller 120 determines a dimming rate that eliminates this difference, and transmits a control signal indicating this dimming rate to the controlled lighting device 200. The dimming rate is the operation amount used in the feedback control system.

Brightness sensor 130 regularly measures the brightness of the illuminated surface, and controller 120 obtains, from brightness sensor 130, the most recent brightness information after transmitting the control signal indicating the dimming rate, and once again performs the set of processes after the comparing.

In this way, controller 120 cyclically performs the determining of the dimming rate based on the brightness target value and the brightness information, as well as the generating and transmitting of the control signal indicating the determined dimming rate. As a result of these processes being repeatedly and continuously executed in lighting system 10 when in operation, the brightness of the illuminated surface is maintained at the brightness target value (or to within a margin of error from the brightness target value).

Controller 120 cyclically performs the determining of the dimming rate based on the brightness target value and the brightness information, as well as the generating and transmitting of the control signal indicating the determined dimming rate. The control signal indicating the dimming rate to be applied to lighting devices 200 that is determined by controller 120 based on at least the brightness information is one example of the first control signal according to this embodiment.

Outside light, which is a source of disruption, depends heavily on nature, and can therefore greatly vary in intensity, but, for example, so long as the cycle of operations from the obtainment to the transmission of the brightness information takes a short amount of time, such as a few seconds, changes large enough to be apparent to the user are not likely to occur within the span of one cycle. Therefore, the feedback control corrects the output of lighting device 200 by making layers of changes small enough to be unnoticeable by the user, in accordance with changes in the outside light.

Here, as described above, lighting control devices 100a through 100c have the same configuration, and all lighting control devices 100 perform operations for the above-described feedback control. Moreover, typically, the length of the above-described cycle is the same across lighting control devices 100. If different cycles are used across lighting control devices 100, all control signals are transmitted at the same time from lighting control devices 100 at a common multiple of the lengths of the cycles of lighting control devices 100. In this way, among lighting control devices 100a through 100c installed in a single room, communication is easily congested when wireless communication is performed routinely and cyclically. Hereinafter, transmission operations for inhibiting such congestion will be described.

### (2-1-2. Transmission of First Control Signal)

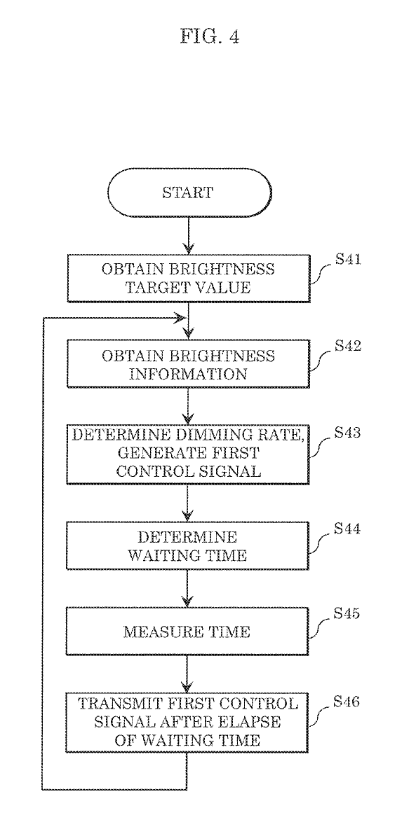

FIG. 4 is a flowchart illustrating the brightness feedback control steps performed in lighting control devices 100.

First, in lighting control device 100, controller 120 obtains the brightness target value from storage 110 (step S41).

Next, controller 120 obtains the brightness information from brightness sensor 130 (step S42).

Next, controller 120 determines a dimming rate based on the brightness target value obtained in step S41 and the brightness information obtained in step S42, and generates a first control signal indicating the determined dimming rate (step S43).

Next, controller 120 determines a waiting time based on the brightness information obtained in step S42 (step S44). These steps will be described in more detail later.

Next, controller 120 measures time using the timer described above (step S45). After elapse of the waiting time, the first control signal is transmitted to the controlled lighting devices 200 via transmitter 140 (step S46). Controller 120 then repeats steps S42 through S46 in the above-described cycle of a few seconds. Note that the commencement of the measuring of time may be a predetermined time that is determined as appropriate; for example, the measuring may commence at the point in time the dimming rate or waiting time is determined, and, alternatively, may commence at a point in time indicated by a time stamp associated with the brightness information obtained by controller 120. In the following example, the measuring of time commences at the point in time the waiting time is determined.

All lighting control devices 100 perform these steps, but the waiting time determined in step S45 is likely to be different across control devices 100. In other words, the intensity of outside light that enters the same room is not necessarily even throughout the room. Thus, when brightness sensor 130 measures the brightness in different locations on the illuminated surface or on different illuminated surfaces, the measurement values of the illuminated surfaces output by the brightness sensors (the brightness values indicated by the brightness information), for example, are not likely to be the same. Accordingly, the waiting times determined using the same method across lighting control devices 100 based on the different brightness information are mutually different. It is therefore likely that first control signals will be transmitted at different times across lighting control devices 100, thereby avoiding communication congestion.

Next, an example of the method used to determine the waiting time will be given. In the following example, the brightness information obtained by controller 120 from brightness sensor 130 is a discrete value between 0 and 255. This discrete value is obtained by, for example, the A/D converter of brightness sensor 130 A/D converting an analog value within a measurable range of the brightness sensor into an 8-bit digital value.

In step S44, controller 120 may use, for example, the brightness information value as the waiting time value, as-is. In this case, if the brightness information value is 123, controller 120 determines the waiting time to be 123 milliseconds. In step S45, when the waiting time of 123 milliseconds elapses from the determined point in time, controller 120 transmits the first control signal via transmitter 140.

Moreover, controller 120 may use the brightness information value as a variable in a predetermined function. As a relatively simple example, a value obtained by multiplying the brightness information value with a constant, or the remainder obtained by dividing the brightness information value by a predetermined value may be used as the waiting time value. For example, when the brightness information value is 123 and the predetermined value is 100, the waiting time may be determined to be 23 milliseconds using the remainder of 23. Moreover, the brightness information value may be used as a seed in a pseudorandom number generation function calculated by controller 120.

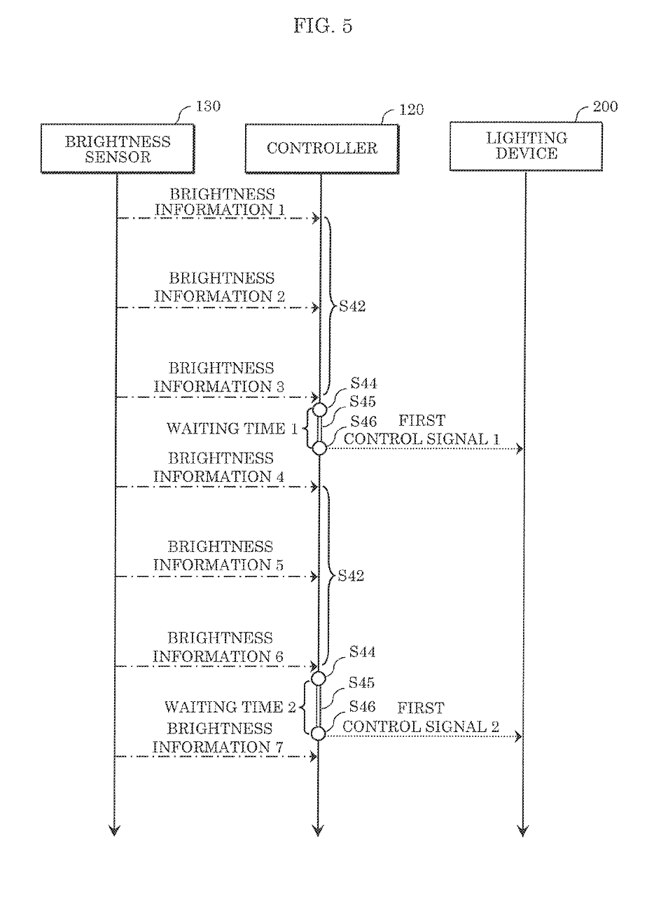

Moreover, the number of brightness information values used in one instance of determining the waiting time is not limited to one. For example, a plurality of brightness information values indicating the most recent measured brightness values may be used. The probability that changes in brightness measurements taken in different locations over a period of time match is lower than the probability that that brightness measurements taken in different locations in a single instance match. Therefore, this method has a higher degree of probability of yielding different waiting times than the method described above in which one brightness information value is used. Next, an example of determining the waiting time based on a plurality of brightness information values will be given with reference to a drawing. FIG. 5 is a sequence chart for illustrating the cycle of steps for determining the waiting time based on a plurality of brightness information values, performed in lighting control devices 100 according to this embodiment.

In FIG. 5, controller 120 obtains brightness information 1 through 3 in a given cycle from brightness sensor 130 (corresponding to step S42 in FIG. 4). Next, controller 120 determines, for example, an arithmetic average of the three values as waiting time 1, based on brightness information 1 through 3 (corresponding to step S44 in FIG. 4). Next, controller 120, for example, measures waiting time 1 starting at the determined point in time for the waiting time (corresponding to step S45 in FIG. 4). When waiting time 1 elapses, controller 120 transmits first control signal 1 via transmitter 140 (corresponding to step S46 in FIG. 4). Although step S43 is omitted in FIG. 5, after step S43, the dimming rate is determined using at least one of brightness information 1 through 3. This constitutes one cycle of the repetition of steps S42 through S46 illustrated in FIG. 4.

In the next cycle, controller 120 obtains brightness information 4 through 6 (corresponding to step S42 in FIG. 4) and repeats the subsequent steps to transmit first control signal 2. Note that waiting time 2 determined in this cycle is longer than waiting time 1, even though the method used to determine waiting time 2 is the same as waiting time 1. This difference results from the waiting times being determined each cycle and there being a difference in brightness information values used to determine the waiting times in the cycles. Therefore, since the time between transmissions in a single lighting control device 100 may vary, it is unlikely for a plurality of lighting control devices 100 to transmit the control signals at the same time, at a common multiple of the lengths of the respective cycles.

Note that the brightness information used to determine the dimming rate and the brightness information used to determine the waiting time need not be the exact same information; the number of units of information used or the information itself may be different. For example, in the example illustrated in FIG. 5, brightness information 3 may be used to determine the dimming rate and brightness information 1 and 2 may be used to determine the waiting time.

Moreover, the brightness information values used to determine the waiting time in a single cycle is not limited to the information resulting from brightness sensor 130 measuring brightness at different points in time, as is exemplified above. For example, brightness information values may be obtained by brightness sensor 130 measuring the brightness in a plurality of locations on the illuminated surface simultaneously.

With the transmission operations performed by lighting system 10 according to this embodiment, communication congestion can be avoided by using measurement values output by the brightness sensors (the brightness values indicated by the brightness information) which are unlikely to match, in order to obtain different waiting times across lighting control devices 100. This method can be implemented at low cost since it is easier to realize with a simple configuration in respect to both hardware and software compared to a method that avoids congestion using carrier sense or a method in which a given lighting control device 100 or a separate device performs focused control over the transmission timing of each lighting control device 100. Moreover, since the task of connecting lighting control devices 100 or performing device recognition between lighting control devices 100 is not required when a new lighting control device 100 is added or an installed lighting control device 100 is replaced, operational costs can be reduced. Therefore, lighting system 10 according to this embodiment is cost efficient and inhibits communication congestion by shifting the transmission timing of the first control signals such that transmission across lighting control devices 100 occurs at different times with a high degree of probability.

### (2-2. Non-Routine Operations)

The routine operations described above are operations performed the majority of the time lighting system 10 is operating. However, in lighting system 10, at times other than when these routine operations are being performed, there may be instances where lighting control devices 100 transmit the control signals at the same time.

### (2-2-1. Outline of Non-Routine Operations)

For example, when signals instructing all lighting devices 200 in lighting system 10 to turn on are transmitted at the same time from remote control 300 to lighting control devices 100, control signals for turning on the controlled lighting devices 200 are transmitted at the same time from lighting control devices 100. Moreover, instruction of execution of energy-saving light emission from demand controller 400 or instruction of ending this execution are typically valid throughout the consumer location, and energy-saving signals indicating this instruction are transmitted to lighting control devices 100 at the same time. It is also possible for control signals for control based on this instruction to be transmitted from lighting control devices 100 at the same time. As such, in each lighting control device 100, a control signal generated based on a signal from an external device that instructs an operation to be performed by lighting device 200 (hereinafter also referred to as an external instruction signal) and transmitted by controller 120 is one example of the second control signal according to this embodiment.

If these second control signals based on an external instruction signal indicating the same instruction to be performed by a plurality of lighting control devices 100 are wirelessly transmitted from the plurality of lighting control devices 100 at the same time, transmission can become congested. Hereinafter, transmission operations for inhibiting such congestion will be described.

### (2-2-2. Transmission of Second Control Signal)

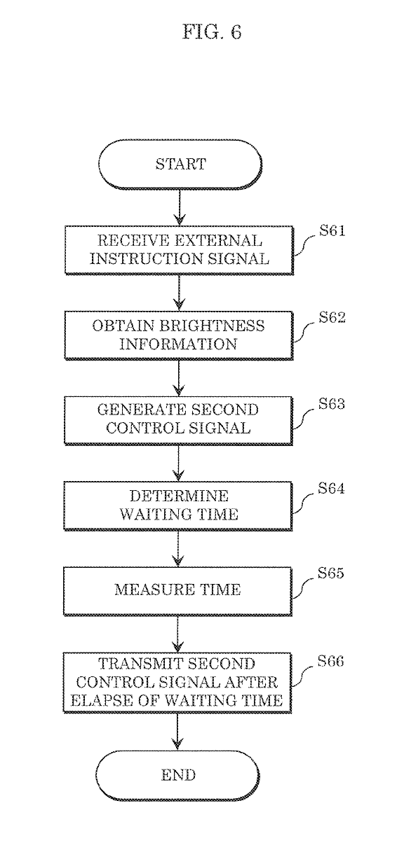

FIG. 6 is a flowchart illustrating steps performed in each lighting control devices 100 from reception of the external instruction signal to transmission of the second control signal.

First, in lighting control device 100, controller 120 receives the external instruction signal via receiver 150 (step S61). The external instruction signal is, for example, an energy-saving signal instructing execution of energy-saving light emission received from demand controller 400.

Next, controller 120 obtains the brightness information from brightness sensor 130 (step S62).

Next, controller 120 generates the second control signal (step S63). Controller 120 may obtain data as necessary and generate the second control signal based on this data. For example, when the external instruction signal obtained in step S61 is the energy-saving signal, controller 120 obtains the dimming rate stored in storage 110 as a set value, and generates the second control signal based on the obtained dimming rate.

Next, controller 120 determines a waiting time based on the brightness information obtained in step S62 (step S64). These steps will be described in more detail later.

Next, controller 120 measures time using the timer described above (step S65). After elapse of the waiting time from the determined point in time for the waiting time, the second control signal is transmitted to the controlled lighting devices 200 via transmitter 140 (step S66).

This is the flow of steps from reception of the external instruction signal to transmission of the second control signal. Afterward, for example, processes from steps S41 (or S42) to S46 in the feedback control are performed.

The method used to determine the waiting time described in “(2-1-2. Transmission of First Control Signal)” may typically be used to determine the waiting time in step S61. Note that, for example, the waiting time before the transmission of the second control signal (hereinafter referred to as the first waiting time) is longer than the waiting time before the transmission of the first control signal (hereinafter referred to as the second waiting time). Accordingly, using a longer waiting time to more greatly vary the transmission timing of signals across lighting control devices 100 makes it possible to more greatly vary the transmission timing throughout lighting system 10 rapidly. This in turn makes it possible to effectively inhibit communication congestion rapidly.

The method of obtaining a first waiting time and a second waiting time that is longer than the first waiting time when the brightness information based on which the first waiting time is determined and the brightness information based on which the second waiting time is determined indicate the same brightness, that is, a single brightness level, may be any given method that yields two waiting times that fall within appropriate ranges. One simple example of such a method is given below.

For example, in lighting control device 100, when the brightness information value is used as the first waiting time value as-is, a value obtained by adding or multiplying the brightness information value with a predetermined positive value may always be used as the second waiting time value.

Moreover, when the value obtained by using the brightness information value as a variable in a predetermined function is used as the first waiting time value, a value obtained by using a function that adds or multiplies a predetermined positive value to the function used to obtain the first waiting time value may be used as the second waiting time. For example, more specifically, when the brightness information value is 123, the brightness information value is divided by 100 to obtain a remainder of 23, and this remainder of 23 is used for the first waiting time value, the first waiting time is determined to be 23 milliseconds. On the other hand, a value obtained by always multiplying this remainder by 20 is used as the second waiting time. In this case, the second waiting time is determined to be 460 milliseconds.

Additionally, when the waiting time is determined based on a plurality of brightness information values, various calculation methods may be used to determine a second waiting time that is longer than the first waiting time, such as using the minimum value among the plurality of values for the first waiting time and using a value obtained by summing the plurality of values for the second waiting time.

### (3. Variations, etc.)

Hereinbefore, lighting control device 100 has been described based on an embodiment, but the present disclosure is not limited to this example.

For example, in the above embodiment, lighting control device 100 is described as a device that performs both routine operations and non-routine operations, but lighting control device 100 may perform one or the other of the operations. In other words, lighting control device 100 may be a device that does not perform routine operations for the feedback control of cyclically transmitting a control signal, but transmits a control signal generated based on an instruction indicated by an external instruction signal after elapse of a waiting time determined based on brightness information. In this case, in lighting system 10, the probability that the second control signals will be transmitted at the same time from a plurality of the lighting control devices 100 that have received the same external instruction signal transmitted at the same time decreases, and as a result, communication congestion is inhibited. Conversely, lighting control device 100 may be a lighting control device that performs only the routine operations described above. In this case, the probability that the continuous first control signal will be cyclically transmitted at the same time from a plurality of the lighting control devices 100 decreases, and as a result, communication congestion is inhibited.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### (4. Advantageous Effects)

Lighting control device 100 according to the above embodiment or variation thereof is a device that controls lighting device 200. Lighting control device 100 includes: brightness sensor 130 that obtains brightness information indicating the current brightness of an illuminated surface illuminated by lighting device 200; controller 120 that obtains the brightness information from brightness sensor 130; and transmitter 140 that wirelessly transmits, to lighting device 200, a control signal generated by controller 120 for controlling lighting device 200.

Controller 120 determines a waiting time based on the brightness information and transmits the control signal to lighting device 200 via transmitter 140 after elapse of the waiting time from a predetermined time.

Lighting control device 100 configured in this manner inhibits communication congestion even when a plurality of lighting control devices 100 are installed close to one another, such as in the same room.

Moreover, controller 120 further determines a dimming rate to be applied to the lighting device based on the brightness information and generates, as the control signal, a first control signal indicating the dimming rate. With lighting control device 100 configured in this manner, the brightness information obtained by brightness sensor 130 is used to determine the dimming rate used in the feedback control for the brightness of the illuminated surface. In other words, in the lighting control device that performs such feedback control, brightness sensor 130 used in feedback control can also be effectively used to inhibit communication congestion.

Moreover, lighting control device 100 further includes a receiver that receives, from an external device, an external instruction signal instructing one of (i) switching lighting device 200 between on and off states and (ii) an operation related to execution of energy-saving light emission by lighting device 200. Controller 120 generates, as the control signal, a second control signal based on the external instruction signal. Here, the external device is, for example, remote control 300 or demand controller 400 according to the embodiment. Since the external instruction signals are simultaneously transmitted from external device to each lighting control device 100, which have the same configuration, the time from generation of the second control signal based on the external instruction signal to completion of transmission preparation is approximately the same across lighting control devices 100. However, since second control signal is transmitted after elapse of a waiting time determined based on the brightness information in each lighting control device 100, communication congestion is inhibited.

Moreover, controller 120 may: determine a first waiting time and a second waiting time longer than the first waiting time, based on brightness information indicating a single brightness level; transmit the first control signal to lighting device 200 via transmitter 140 after elapse of the first waiting time from the predetermined time; and transmit the second control signal to lighting device 200 via transmitter 140 after elapse of the second waiting time from the predetermined time.

In lighting system 10 including a plurality of lighting control devices 100 configured in this manner, for example, when control signals are transmitted from all lighting control devices 100, such as when turning on all lighting devices 200 or at the start of execution of energy-saving light emission by all lighting devices 200, the transmission timing can be greatly varied to further inhibit communication congestion with a high degree of probability. Moreover, by greatly varying the transmission timing, the transmission timing throughout the entire lighting system 10 can be rapidly varied to a great degree. This in turn makes it possible to effectively inhibit transmission congestion rapidly.

Moreover, in one aspect, the present invention may be realized as lighting system 10 including a plurality of lighting control devices 100 each including receiver 150, and at least one of remote control 300 and demand controller 400 as the external device that transmits the external instruction signal.

In this lighting system 10, congestion of transmission by the plurality of lighting control devices 100 can be inhibited and lighting system 10 can be implemented and operated at lower cost than a lighting system that inhibits congestion using a conventional method.

What is claimed is:

1. A lighting control device that controls a lighting device, the lighting control device comprising:
a brightness sensor that obtains brightness information indicating a current brightness of an illuminated surface illuminated by the lighting device;
a controller that obtains the brightness information from the brightness sensor; and
a transmitter that wirelessly transmits, to the lighting device, a control signal generated by the controller for controlling the lighting device,
wherein the controller:
determines a waiting time based on the brightness information; and
transmits the control signal to the lighting device via the transmitter after elapse of the waiting time from a predetermined time.

2. The lighting control device according to claim 1, wherein
the controller:
further determines a dimming rate to be applied to the lighting device based on the brightness information; and
generates, as the control signal, a first control signal indicating the dimming rate.

3. The lighting control device according to claim 2, further comprising
a receiver that receives, from an external device, an external instruction signal instructing one of (i) switching the lighting device between on and off states and (ii) an operation related to execution of energy-saving light emission by the lighting device,
wherein the controller generates, as the control signal, a second control signal based on the external instruction signal.

4. The lighting control device according to claim 3, wherein
the controller:
determines a first waiting time and a second waiting time longer than the first waiting time, based on the brightness information;
transmits the first control signal to the lighting device via the transmitter after elapse of the first waiting time from the predetermined time; and
transmits the second control signal to the lighting device via the transmitter after elapse of the second waiting time from the predetermined time.

5. A lighting system, comprising:
a plurality of lighting control devices, each of which is the lighting control device according to claim 3; and
the external device, wherein:
the external device includes at least one from the group consisting of a remote control and a demand controller, and
the external device transmits the external instruction signal to the plurality of lighting control devices simultaneously.
